(19) United States
(12) Patent Application Publication
(10) Pub. No.: US 2009/0239640 A1
(43) Pub. Date: Sep. 24, 2009

(54) Slot Machine Capable Of Displaying Special Picture Consisting Of A Plurality Of Picture Pieces And Control Method Thereof

(75) Inventor: Kazumasa Yoshizawa, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: Aruze Corp., Tokyo (JP)

(21) Appl. No.: 12/403,770

(22) Filed: Mar. 13, 2009

Related U.S. Application Data
(60) Provisional application No. 61/038,981, filed on Mar. 24, 2008.

(51) Int. Cl. A63F 9/24; A63F 13/00

(52) U.S. Cl. 463/20; 463/30

(57) ABSTRACT

According to a slot machine of the present invention, special symbols may be stop-displayed to a symbol display. Each of the special symbols shows a picture piece for forming a predetermined picture. In a case where the picture pieces shown in the special symbols stop-displayed in a predetermined display area in the symbol display form the predetermined picture, a feature game is generated.

### CROSS-REFERENCE TO RELATED APPLICATIONS

This application claims benefit of priority based on US Provisional Patent Application No 61/038,981 filed on Mar. 24, 2008. The contents of this application are incorporated herein by reference in their entirety.

### BACKGROUND OF THE INVENTION

1. Field of the Invention

The present invention relates to a slot machine capable of displaying a special picture consisting of a plurality of picture pieces and a control method thereof.

2. Discussion of the Background

In conventional slot machines, when a player inserts game media such as medals, coins or bills into an insertion slot of the slot machine and presses a spin button, then a plurality of symbols are scroll-displayed to a display portion provided on the front surface of a casing and, thereafter, the respective symbols are automatically stopped, as disclosed in U.S. Pat. Nos. 6,960,133, 6,012,983 and 6,093,102. In this case, when scroll-display of respective symbols starts by an input from the spin button, symbols are selected using random numbers, and the selected symbols are stop-displayed to the display portion. Then, when a combination of the stop-displayed symbols along a winning line is a predetermined winning combination (prize) a payout is conducted.

Further, among conventional slot machines, there are some slot machines which conduct two types of payouts which are a payout determined according to the combinations of symbols rearranged along winning lines and a payout determined according to the number of displayed scatter symbols, as disclosed in U.S. Pat. No. 6,604,999 and US 2002-0065124-A1. In such a slot machine which conducts payouts based on such scatter symbols, there is no relationship between payouts and T posit-ions at which the scatter symbols are displayed.

Further, in the conventional slot machines, there exists a slot machine executing a game different from a basic game (in the present description, referred to as feature game, e.g. bonus game comparatively advantageous for the player). Examples of the feature game include a free game. The free game is a game that can be played without consuming game media. For example, a slot machine executing a free game as a secondary game in the case of establishment of a predetermined condition (symbols being aligned in a specific arrangement) in the basic game is disclosed in AU1972901-A1.

Such a slot machine executing the feature game is generally configured to execute the feature game in the case that the symbols are aligned in a predetermined arrangement or in the case that specific symbols in a predetermined number are displayed. Here, the condition for generation of the feature game is comparatively similar to the condition for offering of a normal payout. Accordingly, there tends to be happened a case where it is visibly unclear to the player that a display of which symbols in which arrangement leads to a profit of the feature game to the player. Consequently, it becomes hard to make the player have an expectation for the feature game, so that there has been a problem that the slot machine fails to fully attract an interest of the player in the game.

In light of the aforementioned problem, the present invention has been devised, and an object of the present invention is to provide a slot machine capable of fully attracting an interest of a player in a feature game and a control method thereof.

The contents of U.S. Pat. No. 6,960,133, U.S. Pat. No. 6,012,983, U.S. Pat. No. 6,093,102, U.S. Pat. No. 6,604,999, U.S. 2002-0065124-A1, and AU1972901-A1 are incorporated herein by reference in their entirety.

### SUMMARY OF THE INVENTION

The present invention provides a slot machine having the following configuration.

That is, the slot machine comprises: a symbol display capable of variably displaying a plurality of symbols including normal symbols and special symbols each showing a picture piece for forming a predetermined picture; and a controller. The controller is programmed to execute processing of (A) executing a normal game after stop-displaying the plurality of symbols subsequent to a variable display of the plurality of symbols to the symbol display, the normal game being a game offering a normal payout corresponding to the stop-displayed normal symbols or a combination of the stop-displayed normal symbols; and (B) executing a feature game different from the normal game, as well as stop-displaying a plurality of feature symbols different from the plurality of symbols after variably displaying the plurality of feature symbols in a predetermined display area in the symbol display, as triggered by formation of the predetermined picture by the picture pieces shown by the special symbols stop-displayed in the predetermined display area, out of the special symbols stop-displayed to the symbol display in the normal game executed in the processing (A).

According to the slot machine, the special symbols may be stop-displayed to the symbol display. Each of the special symbols shows a picture piece for forming a predetermined picture. In the case that the picture pieces shown in the special symbols stop-displayed in a predetermined display area (for example, three columns excluding a leftmost column and a rightmost column in a symbol matrix including three rows and five columns) in the symbol display (for example, display) form the predetermined picture, the feature game is generated. Namely, a condition for generation of the feature game is a display of a predetermined picture (in the present description, also referred to as “completion of a predetermined picture”), which is different from a mere arrangement or a mere number of the symbols and is visibly very clear to the player. Accordingly, it is easier to have the player have an expectation for the completion of such a predetermined picture, and player's interest it the feature game can be fully attracted.

Further, according to the slot machine, as triggered by an establishment of such a condition for the generation of a feature game, the feature symbols are stop-displayed after variably displayed in the predetermined display area (for example, three columns excluding a leftmost column and a rightmost column in a symbol matrix including three rows and five columns). In the case that the predetermined picture is completed, it is highly possible that the player's attention is focused on the area displaying the picture therein. In such area, a variable display of the feature symbols is started. Further, the player usually does not experience another variable display of the symbols after the symbols are once stop-displayed and before the next game is started. Accordingly, it is possible to have the player visibly enjoy a state of the variable display of the feature symbols, as well as having the player surprised. Further, the player's expectation for the completion of the predetermined picture can be increased. As a result, the player's interest in the feature game is also increased.

Further, the slot machine of the present invention preferably has the following configuration.

That is, the processing (A) includes processing of displaying variably the plurality of symbols in a predetermined direction. The processing (B) includes processing of displaying variably the plurality of feature symbols in a direction different from the predetermined direction.

According to the slot machine, the normal symbols and the special symbols are variably displayed in different directions. Accordingly, since the direction of the variable display of the feature symbols is different from the direction familiar to the player, it is possible to provide a novel element to the player watching the state of the variable display of the feature symbols. Accordingly, the player's expectation for the completion of the predetermined picture can be further increased.

Further, the slot machine of the present invention preferably has the following configuration.

That is, the slot machine comprises: a symbol display capable of variably displaying a plurality of symbols including normal symbols and special symbols each showing a picture piece for forming a predetermined picture; and a controller. The controller is programmed to execute processing of (A) executing a normal game after stop-displaying the plurality of symbols subsequent to a variable display of the plurality of symbols to the symbol display; the normal game being a game offering a normal payout corresponding to the stop-displayed normal symbols or a combination of the stop-displayed normal symbols; and (B) executing a feature game different from the normal game, as well as stop-displaying feature symbols each showing a feature picture piece for forming a specific picture so as to form the specific picture, after variably displaying the feature symbols in a predetermined display area in the symbol display, as triggered by formation of the predetermined picture by the picture pieces shown by the special symbols stop-displayed in the predetermined display area, out of the special symbols stop-displayed to the symbol display in the normal game executed in the processing (A).

According to the slat machine, the special symbols may be stop-displayed to the symbol display. Each of the special symbols shows a picture piece for forming a predetermined picture. In the case that the picture pieces shown in the special symbols stop-displayed in a predetermined display area (for example, three columns excluding a leftmost column and a rightmost column in a symbol matrix including three rows and five columns) in the symbol display (for example, display) form the predetermined picture, the feature game is generated. Namely, a condition for generation of the feature game is a display of a predetermined picture, which is different from a mere arrangement or a mere number of the symbols and is visibly very clear to the player. Accordingly, it is easier to have the player have an expectation for the completion of such a predetermined picture, and player's interest in the feature game can be fully attracted.

Further, according to the slot machine, as triggered by an establishment of such a condition for the generation of a feature game, the feature symbols are stop-displayed after variably displayed in the predetermined display area (for example, three columns excluding a leftmost column and a rightmost column in a symbol matrix including three rows and five columns). In the case that the predetermined picture is completed, it is highly possible that the player's attention is focused on the area displaying the picture there in. In such area, a variable display of the feature symbols is started. Further, the player usually does not experience another variable display of the symbols after the symbols are once stop-displayed and before the next game is started. Accordingly, it is possible to have the player visibly enjoy a state of the variable display of the feature symbols, as well as having the player surprised. Further, the player's expectation for the completion of the predetermined picture can be increased. As a result, the player's interest in the feature game is also increased.

Furthermore, according to the slot machine, each feature symbol shows a feature picture piece for forming a specific picture. The feature symbols are stop-displayed so as to form the specific picture. Namely, after the completion of the predetermined picture, the specific picture is displayed as a result of sorting of the symbols. Accordingly, the player can visibly enjoy sequential events including the completion of the predetermined picture, the variable display of the feature symbols, and the display of the specific picture. Consequently, the player's interest in the predetermined picture, specific picture and the feature symbols can be significantly increased so that the player can be absorbed in the game.

Further, the slot machine of the present invention preferably has the following configuration.

That is, a plurality of types of the specific picture are provided. The controller is further programmed to execute processing of (C) determining a type of the specific picture. The processing (B) is processing of (B-1) stop-displaying the feature symbols so as to form the specific picture of the type determined in the processing (C) after variably displaying the feature symbols in a predetermined display area in the symbol display, as triggered by formation of L the predetermined picture by the picture pieces shown by the special symbols stop-displayed in the predetermined display area, out of the special symbols stop-displayed to the symbol display in the normal game executed in the processing (A), and (B-2) executing a feature game corresponding to the type of the specific picture determined in the processing (C).

According to the slot machine, a plurality of the specific picture are provided and a single type of the specific picture is determined at a predetermined timing. After the completion of the predetermined picture, the feature symbols are variably displayed and then stop-displayed so as to form the specific picture of the determined type. Then, the feature case corresponding to the determined type of the specific picture is executed. Accordingly, it is possible to have the player recognize what type of the feature game is to be executed by watching the type of the specific picture formed by the stop-displayed feature symbols. Therefore, it is possible to have the player greatly interested in which specific picture to be displayed. Accordingly, in the case that the displayed specific picture is corresponding to the feature game desired by the player, the player may be delighted, and in the case that the displayed specific picture is corresponding to the feature game not desired by the player, the player may be disappointed. As a result, what type of the specific picture is displayed can take the player through emotional ups and downs. Consequently, the player can be absorbed in the game.

Further, the present invention provides a control method of a slot machine, the method having a following configuration.

That is, the control method of a slot machine comprises steps of: (A) executing a normal game after stop-displaying a plurality of symbols including normal symbols and special symbols each showing a picture piece for forming a predetermined picture subsequent to a variable display of the plurality of symbols to a symbol display, the normal game being a game offering a normal payout corresponding to the stop-displayed normal symbols or a combination of the stop-displayed normal symbols; and (B) executing a feature game different from the normal game, as well as stop-displaying a plurality of feature symbols different from the plurality of symbols after variably displaying the plurality of feature symbols in a predetermined display area in the symbol display, as triggered by formation of the predetermined picture by the picture pieces shown by the special symbols stop-displayed in the predetermined display area out of the special symbols stop-displayed to the symbol display in the normal game executed in the step (A).

According to the control method of the slot machine, the special symbols may be stop-displayed to the symbol display. Each of the special symbols shows a picture piece for forming a predetermined picture. In the case that the respective picture pieces shown in the special symbols stop-displayed in a predetermined display area (for example, three columns excluding a leftmost column and a rightmost column in a symbol matrix including three rows and five columns) in the symbol display (for example, display) form the predetermined picture, the feature game is generated. Namely, a condition for generation of the feature game is a display of a predetermined picture, which is different from a mere arrangement or a mere number of the symbols and is visibly very clear to the player. Accordingly, it is easier to have the player have an expectation for the completion of such a predetermined picture, and player's interest in the feature game can be fully attracted.

Further, according to the control method of the slot machine, as triggered by an establishment of such a condition for the generation of a feature game, the feature symbols are stop-displayed after variably displayed in the predetermined display area (for example, three columns excluding a leftmost column and a rightmost column in a symbol matrix including three rows and five columns). In the case that the predetermined picture is completed, it is highly possible that the player's attention is focused on the area displaying the picture therein In such area, a variable display of the feature symbols is started. Further, the player usually does not experience another variable display of the symbols after the symbols are once stop-displayed and before the next game is started. Accordingly, it is possible to have the player visibly enjoy a state of the variable display of the feature symbols, as well as having the player surprised. Further, the player's expectation for the completion of the predetermined picture an be increased. As a result, the player's interest in the feature game is also increased.

Further, the present invention provides a control method of a slot machine, the method having a following configuration.

That is the control method of a slot machine comprises steps of: (A) executing a normal game, after stop-displaying a plurality of symbols including normal symbols and special symbols each showing a picture piece for forming a predetermined picture subsequent to a variable display of the plurality of symbols to a symbol display, the normal game being a game offering a normal payout corresponding to the stop-displayed normal symbols or a combination of the stop-displayed normal symbols; and (B) executing a feature game different from the normal game, as well as stop-displaying feature symbols each showing a feature picture piece for forming a specific picture so as to form the specific picture, after variably displaying the feature symbols in a predetermined display area in the symbol display, as triggered by formation of the predetermined picture by the picture pieces shown by the special symbols stop-displayed in the predetermined display area, out of the special symbols stop-displayed to the symbol display in the normal game executed in the step (A).

As thus described, according to the control method of the slot machine, the special symbols may be stop-displayed to the symbol display. Each of the special symbols shows a picture piece for forming a predetermined picture. In the case that the picture pieces shown in the special symbols stop-displayed in a predetermined display area (for example, three columns excluding a leftmost column and a rightmost column in a symbol matrix including three rows and five columns) in the symbol display (for example, display) form the predetermined picture, the feature game is generated. Namely, a condition for generation of the feature game is a display of a predetermined picture, which is different from a mere arrangement or a mere number of the symbols and is visibly very clear to the player. Accordingly, it is easier to have the player have an expectation for the completion of such a predetermined picture, and player's interest in the feature game can be fully attracted.

Further, according to the control method of the slot machine, as triggered by an establishment of such a condition for the generation of a feature game, the feature symbols are stop-displayed after variably displayed in the predetermined display area (for example, three columns excluding a leftmost column and a rightmost column in a symbol matrix including three rows and five columns). In the case that the predetermined picture is completed, it is highly possible that the player's attention is focused on the area displaying the picture therein. In such area, a variable display of the feature symbols is started. Further, the player usually does not experience another variable display of the symbols after the symbols are once stop-displayed and before the next game is started. Accordingly, it is possible to have the player visibly enjoy a state of the variable display of the feature symbols as well as having the player surprised. Further, the player's expectation for the completion of the predetermined picture can be increased. As a result, the player's interest in the feature game is also increased.

Furthermore, according to the control method of the slot machine, each feature symbol shows a feature picture piece for forming a specific picture. The feature symbols are stop-displayed so as to form the specific picture. Namely, after the completion of the predetermined picture, the specific picture is displayed as a result of sorting of the symbols. Accordingly, the player can visibly enjoy sequential events including the completion of the predetermined picture, the variable display of the feature symbols, and the display of the specific picture. Consequently, the player's interest in the predetermined picture, specific picture and the feature symbols can be significantly increased, so that the player can be absorbed in the game.

### BRIEF DESCRIPTIONS OF DRAWINGS

FIG. 1A is a view illustrating an exemplary symbol matrix.

FIG. 1B is a view illustrating an exemplary image to be displayed to a lower image display panel.

FIG. 1C is another view illustrating an exemplary image to be displayed to a lower image display panel.

FIG. 1D is another view illustrating an exemplary image to be displayed to a lower image display panel.

FIG. 1E is a view illustrating an exemplary symbol matrix.

FIG. 1F is a view illustrating another exemplary symbol matrix.

FIG. 1G is a view illustrating another exemplary symbol matrix.

FIG. 1H is a view illustrating another exemplary symbol matrix.

FIG. 1I is a view illustrating another exemplary symbol matrix.

FIG. 2A is a view illustrating a feature game determination table.

FIG. 2B is a view illustrating a relation among a type and a number of a feature game and a specific picture.

FIG. 3 is a perspective view illustrating the external appearance of a slot machine.

FIG. 4 is a block diagram illustrating an internal configuration of the slot machine illustrated in FIG. 3.

FIG. 5 is a flowchart illustrating main processing executed in a slot machine 10.

FIG. 6 is a flowchart illustrating a subroutine of slot machine game execution processing.

FIG. 7 is a view illustrating a relation among a type and a number of rearranged normal symbols and a number of coin-outs.

FIG. 8 is a flowchart illustrating a procedure of activation processing.

FIG. 9 is a view illustrating peripheral device initialization processing.

FIG. 10 is a flowchart illustrating a subroutine of activation processing executed by a central controller.

FIG. 11 is a perspective view illustrating an external appearance of a slot machine according to another embodiment.

### DESCRIPTION OF THE EMBODIMENTS

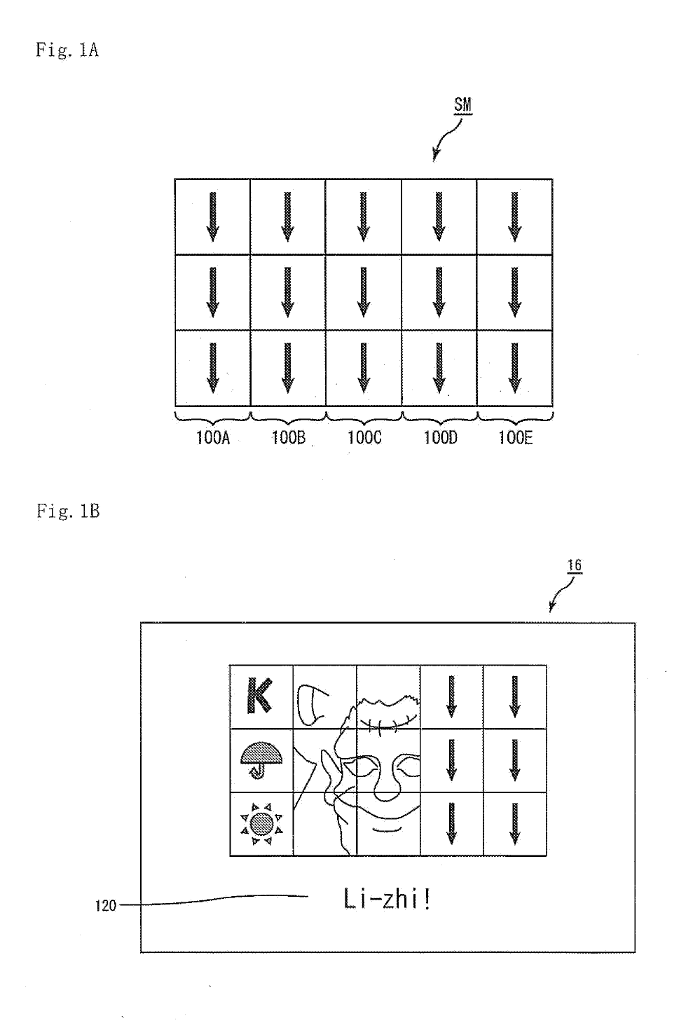

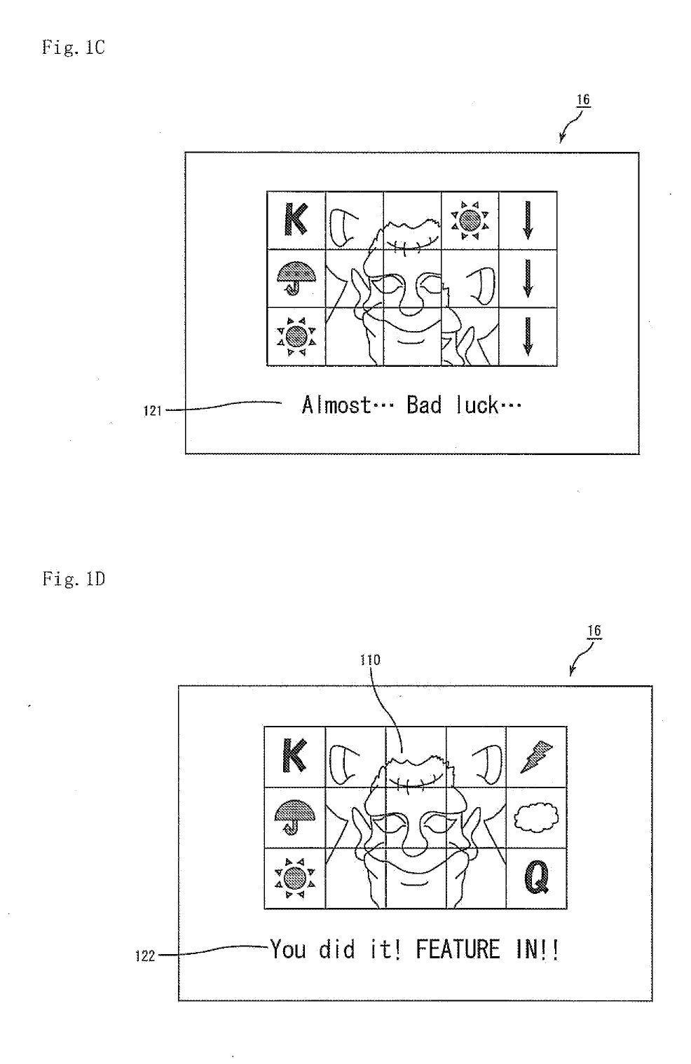

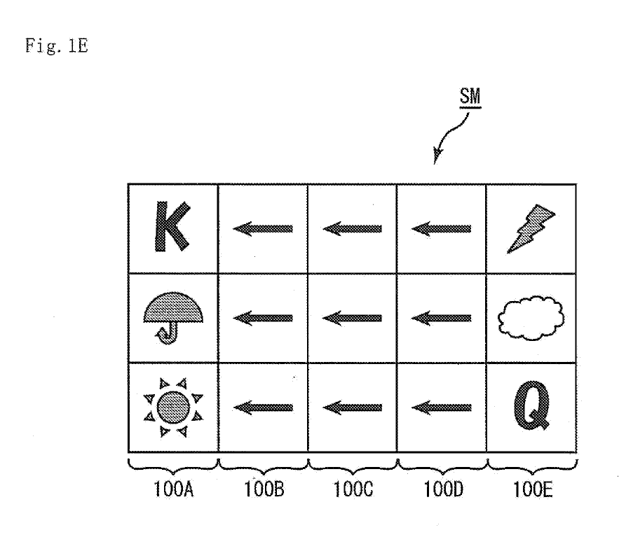

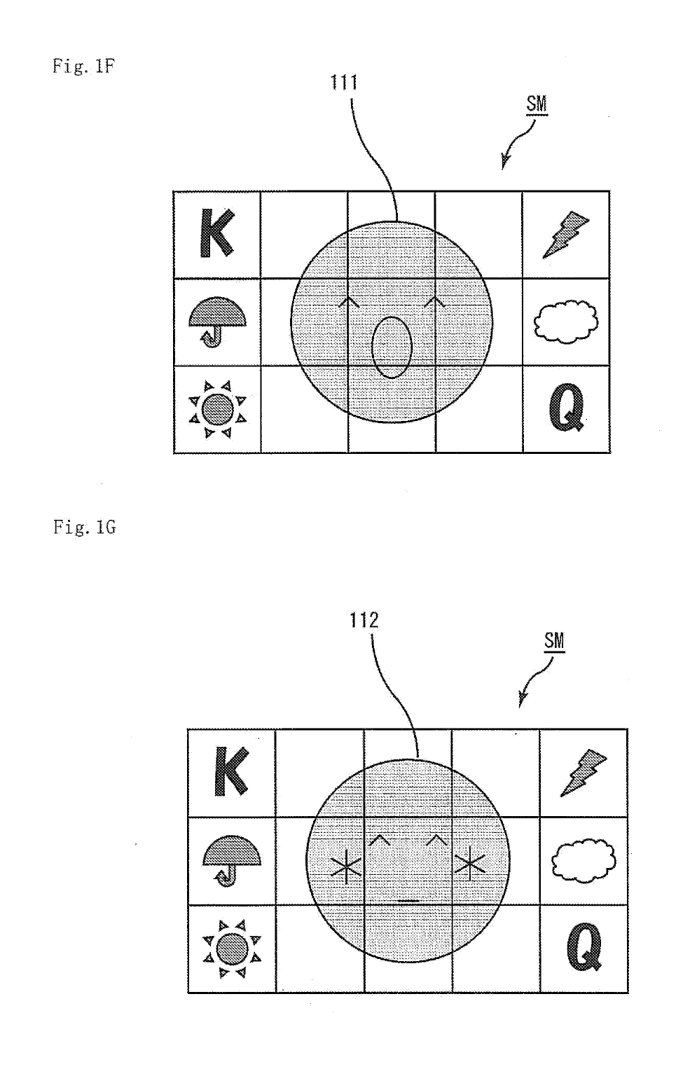

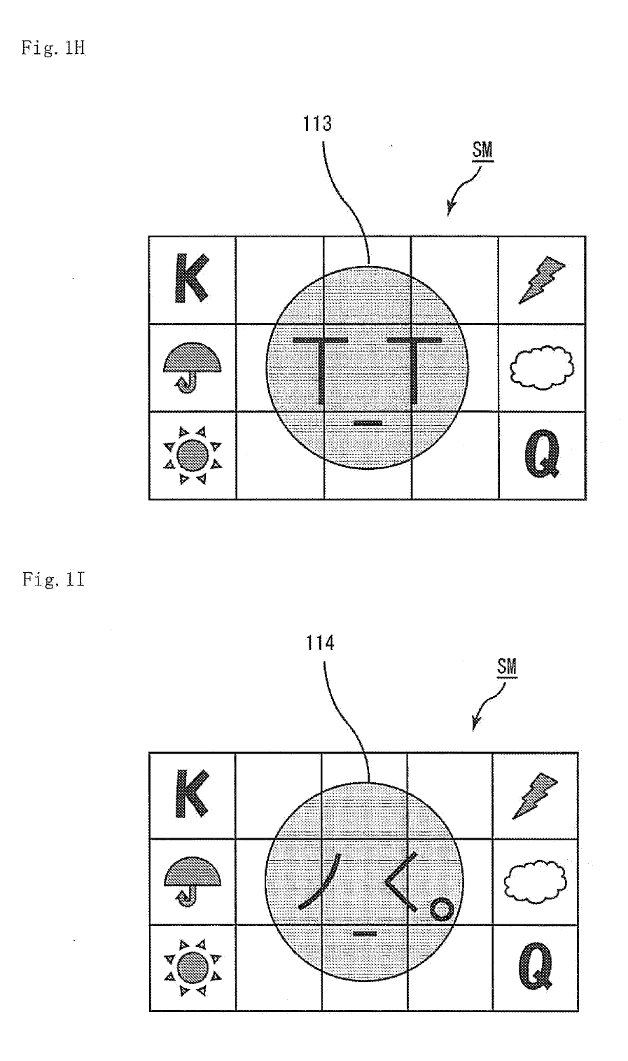

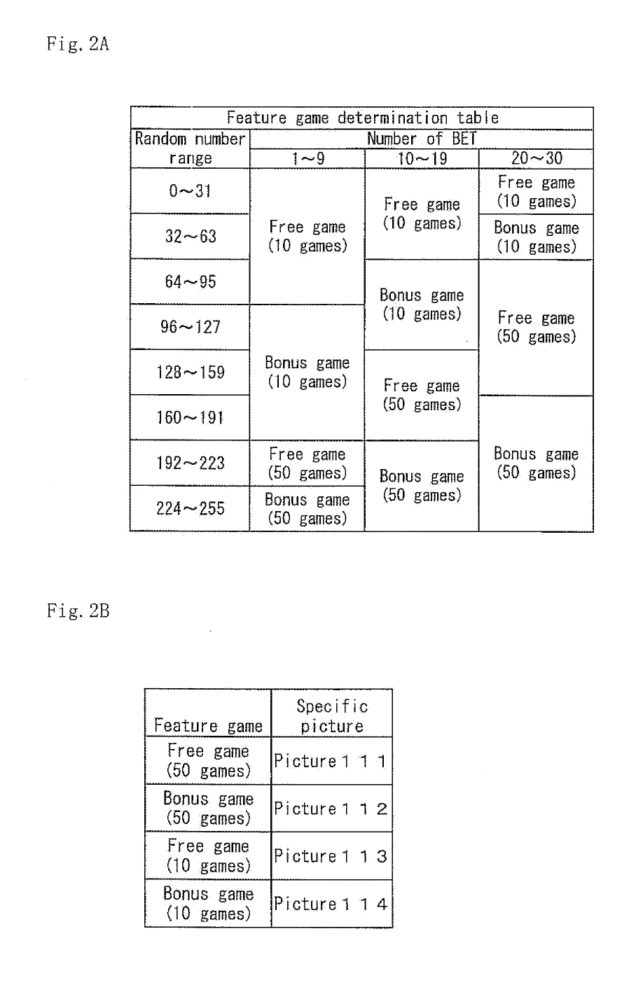

A general description of a present embodiment will be given by using FIG. 1A to FIG. 1I, and FIGS. 2A and 2B.

FIG. 1A is a view illustrating an exemplary symbol matrix.

FIGS. 1B to 1D are views each illustrating an exemplary image to be displayed to a lower image display panel.

FIGS. 1E to 1I are views each illustrating another exemplary symbol matrix.

FIG. 2A is a view illustrating a feature game determination table.

FIG. 2B is a view illustrating a relation among a type and a number of a feature game and a specific picture.

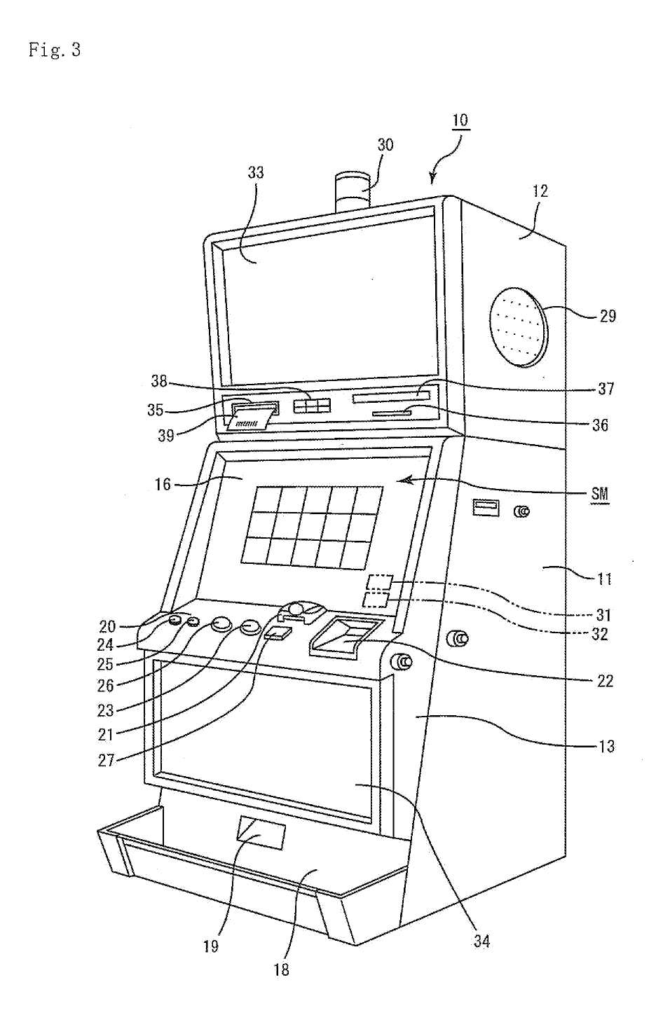

A symbol matrix SM illustrated in FIG. 1A is displayed to a lower image display panel 16 (a symbol display of the present invention) provided in a slot machine 10 (see FIG. 3). The symbol matrix SM is capable of rearranging a total of 15 symbols in three rows and five columns therein. The symbol matrix SM includes a first display area 100A, a second display area 100B, a third display area 100C, fourth display area 100D, and a fifth display area 100E.

Further, hereinafter, three rows included in the symbol matrix SM are also referred to simply as “upper row”, “middle row”, and “lower low”.

When a start button 23 (see FIG. 3) provided in the slot machine 10 is pressed by a player, scrolling of symbols is started in the symbol matrix S as illustrated in FIG. 1A. Then, the symbols are rearranged in order of the first display area 100A, the second display area 100B, the third display area 100C, the fourth display area 100D, and the fifth display area 100E.

An example illustrated in FIG. 1B shows a state that three normal symbols are rearranged in the first display area 100A and six special symbols are rearranged in the second display area 100B to the third display area 100C.

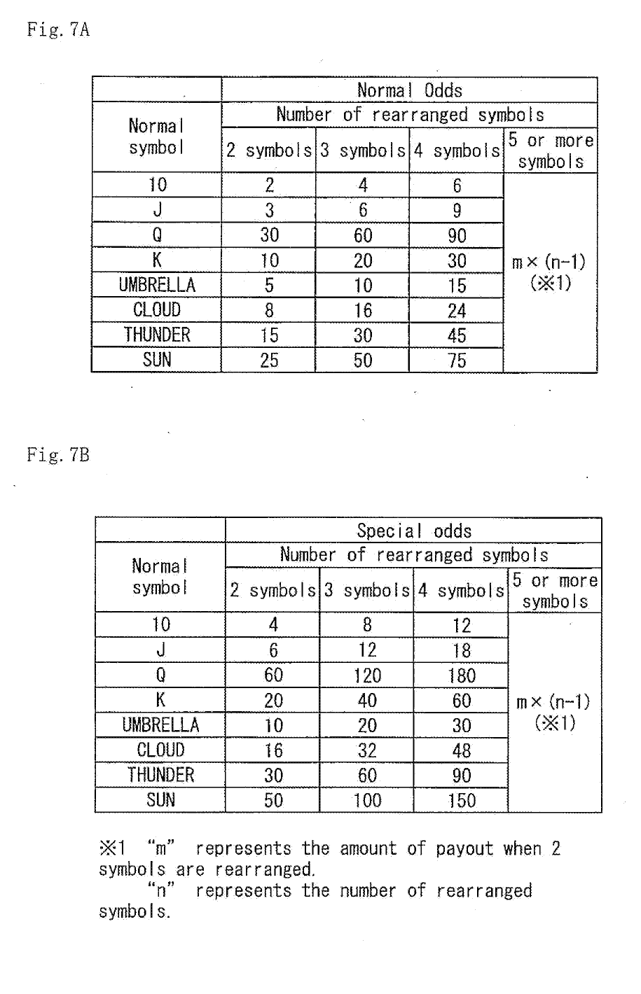

There are eight types of the normal symbol, that is, “10”, “J”, “Q”, “K”, “UMBRELLA”, “CLOUD”, “THUNDER”, and “SUN”. All the normal symbols comprise so-called scatter symbols, and a payout is offered based on a type and a number of the rearranged normal symbols (see FIG. 7). As illustrated in FIG. 7, a number of coin-outs in the case of a BET of a single coin (hereinafter, also referred to as odds) is determined for each type and each number of the normal symbols.

The special symbol shows a picture piece for forming a predetermined picture (picture 110, see FIG. 1D). FIG. 15 illustrates a li-zhi state factor completion of the predetermined picture (one more symbol array is needed for completion of the predetermined picture). Namely, in the case that appropriate special symbols are rearranged in the fourth display area 100D, the predetermined picture is displayed by the special symbols rearranged in the second display area 100B to the Fourth display area 100D. The display of the predetermined picture by the special symbols rearranged in the second display area 100B to the fourth display area 100D is also referred to as “The predetermined picture is completed.” in the present description.

In FIG. 1B, as triggered by the li-zhi state for completion of the predetermined picture, a li-zhi text image 120 showing a text of “Li-zhi!” is displayed to the lower image display panel 16.

Then, the symbols are rearranged in the fourth display area 100D. FIG. 1C shows a state that the predetermined picture has not been completed. As triggered by this, a bad-luck image 121 showing a text of “Almost . . . . Bad luck . . . ” is displayed to the lower image display 16.

On the other hand, FIG. 1D shows a state that the predetermined picture has been completed. As triggered by this, a picture-completion text image 122 showing a text of “You did it! FEATURE IN!!” is displayed to the lower image display panel 16.

In the slot machine 10 according to the present embodiment, the feature game is executed as triggered by the completion of the predetermined picture.

Subsequently, the feature game will be described by using FIGS. 1E to 1I, and FIGS. 2A and 9B.

When the predetermined picture is completed, as illustrated in FIG. 1E, a scroll, display of feature symbols is started in the display areas (the second display area 100B to the fourth display area 100D) in which the special symbols forming the predetermined picture have been displayed. The scrolling here is sideways scrolling. On the other hand, the scrolling on rearrangement of the normal symbols and the special symbols is downward scrolling (see FIG. 1A).

The feature symbol shows a picture piece for forming a specific picture (picture 111 to picture 114, see FIG. 1F to FIG. 1I).

After the scrolling illustrated in FIG. 1E, the feature symbols are rearranged in the second display area 100B to the fourth display area 1000.

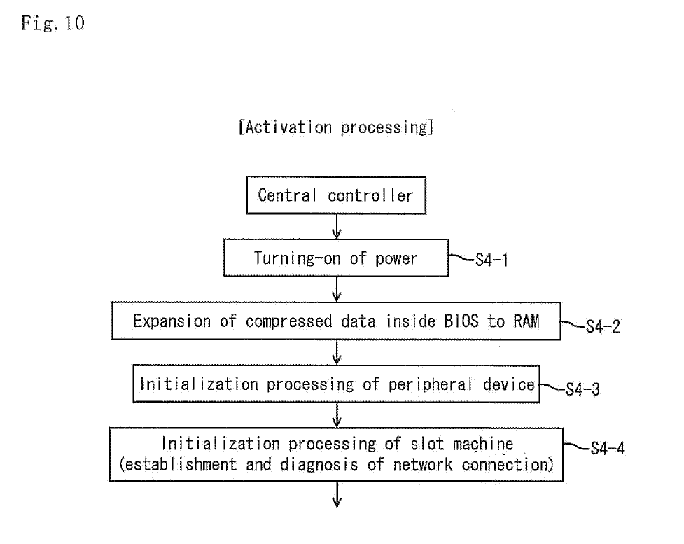

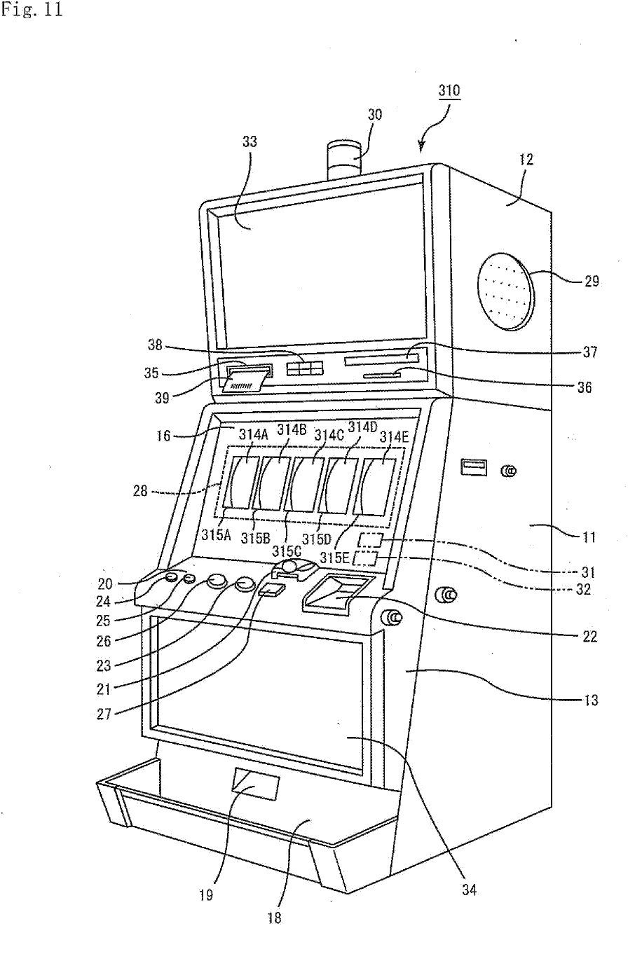

In the second display area 100B to the fourth display area 1000, any one of the picture 111 (see FIG. 1F), the picture 112 (see FIG. 10), the picture 113 (see FIG. 1H), and the picture 114 (see FIG. 1I) is displayed by rearrangement of the feature symbols.

The specific pictures (picture 111 to picture 114) are respectively associated with the type and the number of the feature game executed as triggered by the completion of the predetermined picture (see FIG. 2B). The types of the feature game include a free game and a bonus game.

During a free game period, the slot machine game is executed even an game medium is not BET. During the bonus game period, the payout is offered based or, relatively big odds (special odds, see FIG. 7B).

In the case that the picture 111 shown in FIG. 1F is displayed, the free game is executed for 50 times. In the case that the picture 112 shown in FIG. 1G is displayed, the bonus game is executed for 50 times. In the case that the picture 113 shown in FIG. 1H is displayed, the free game is executed for 1.0 times. In the case that the picture 114 shown in FIG. 1I is displayed, the bonus game is executed for 10 times.

As illustrated in FIG. 2A, the type and the number of the feature game is determined based on the number of BET. “1 to 9”, “10 to 19”, “20 to 30” in the feature game determination table respectively show ranges in which the number of BET may be included. For each of the ranges, the type and the number of the feature game is set in association with a range of a random number.

In the snot machine 10 according to the present embodiment, the type and the number of the feature game is determined based on the number of BET and the feature game determination table, as triggered by the completion of the predetermined picture. Then, the feature symbols are rearranged so as to complete the specific picture corresponding to the type of the number of the determined feature game.

There has been described the outline of the present embodiment.

Hereinafter, the first embodiment will be described in more detail.

FIG. 3 is a perspective view illustrating the external appearance of the slot machine.

In the slot machine 10, a coin, a bill, or electronic valuable information corresponding thereto is used as a game medium. However, in the present invention, a game medium is not particularly limited. Examples of the game medium may include a medal, a token, electronic money, or a ticket. It should be noted that the ticket is not particularly limited, and examples thereof include a ticket with a bar code, which will be described later.

Here, the slot machine 10 is a stand-alone type slot machine that is not connected to a network, but the present invention can also be applied to a slot machine connected to a network.

The slot machine 10 includes: a cabinet 11; a top box 12 placed on the upper side of the cabinet 11; and a main door 13 provided at the front face of the cabinet 11. The lower image display panel 16 is provided in front of the main door 13. The lower image display panel 16 includes a liquid crystal display panel and the symbol matrix SM (see FIG. 1A) is displayed thereto. In the lower image display panel 16, there are provided a number-of-credits display section 31 and a number of payouts display section 32 (not shown).

The number-of-credits display section 31 displays an image indicating the number of credited coins. The number-of-payouts display section 32 displays an image indicating the number of coins to be paid out as the payout.

Further, a touch panel 69, which is not shown in the figure, is provided on the front face of the lower image display panel 16, and the player can input various kinds of commands by operating the touch panel 69.

Below the lower image display panel 16, there are provided a control panel 20 comprised of a plurality of buttons 23 to 27 with each of which a command according to the game progress is inputted by the player, a coin receiving slot 21 through which a coin is accepted into the cabinet 11, and a bill validator 22.

The control panel 20 is provided with a start button 93, a change button 24, a CASHOUT button 25, a 1-BET button 26, and a maximum BET button 27. The start button 23 is used for inputting a command to start a game. The change button 24 is used for making a request of staff at a recreation facility for exchange. The CASHOUT button 25 is used for inputting a command to pay out credited coins to a coin tray 18.

The 1-BET button 26 is used for inputting a command to BET one coin on a game out of credited coins. The maximum BET button 27 is used for inputting a command to BET the maximum number (30 coins in the present embodiment) of coins that can be bet on a single game out of credited coins.

The bill validator 22 not only discriminates a regular bill from a false bill, but also accepts the regular bill into the cabinet 11. It should be noted that the bill validator 22 may be configured so as to be capable of reading a later-described ticket 39 with a barcode. At the lower front 15, face of the main door 13, namely below the control panel 20, there is provided a belly glass 34 on which a character or the like of the slot machine 10 is drawn.

At the front face of the top box 12, an upper image display panel 33 is provided. The upper image display panel 33 is provided with a liquid crystal panel to display, for example, an image representing an introduction of the contents of a game or a description of a rule of the game.

Further, the top box 12 is provided with a speaker 29. Below the upper image display panel 33, there are provided a ticket printer 35, a card reader 36, a data display 37, and a keypad 38. The ticket printer 35 prints on a ticket a barcode as coded data of the number of credits, date and time, an identification number of the slot machine 10, and the like, and outputs the ticket as a ticket 39 with a barcode. The player can make another slot machine read the ticket 39 with a barcode to play a game thereon, or can exchange the ticket 39 with a barcode with bills or the like at a predetermined place in the recreation facility (for example, a cashier in a casino).

The card reader 36 reads data from a smart card and writes data into the smart card. The smart card is a card owned by the player, and for example, data for identifying a player and data on a history of games played by the player are stored therein. Data corresponding to a coin, a bill, or a credit may be stored in the smart card. Further, in place of the smart card, a magnetic stripe card may be adopted. The data display 37 is comprised of a fluorescent display or the like, and displays, for example, data read by the card reader 36 or data inputted by the player through the keypad 38. The keypad 36 is used for inputting a command and data concerning the issue of a ticket and the like.

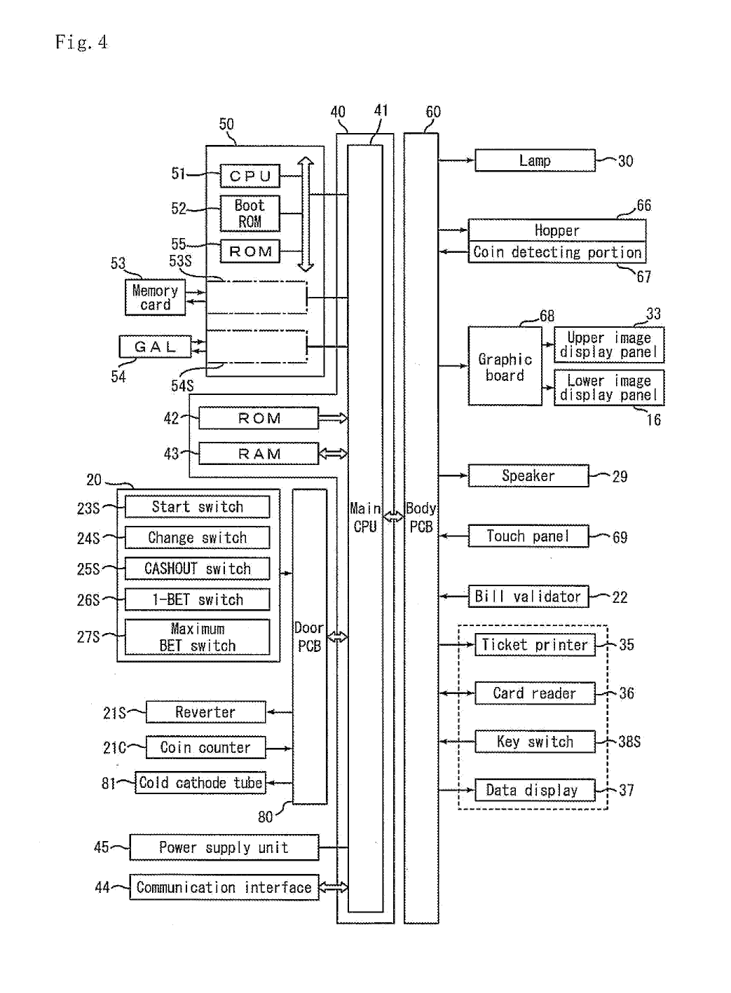

FIG. 4 is a block diagram showing an internal configuration of the slot machine shown in FIG. 3.

A gaming board 50 includes a CPU (Central Processing Unit) 51, a ROM 55, and a boot ROM 52 which are interconnected to one another via an internal bus, a card slot 53S corresponding to a memory card 53, and an IC socket 54S corresponding to a GAL (Generic Array Logic) 54.

The memory card 53 is formed from a non-volatile memory such as CompactFlash (registered trademark) and stores game programs and game system programs. The game programs include a symbol selection program. The aforementioned symbol selection program is a program for determining the symbols (normal symbol and special symbol) to be rearranged in the symbol matrix SM and the multiplying-factor symbol to be stop-displayed by the multiplying-factor reel 106, The aforementioned symbol selection program includes symbol weighing data in association with a plurality of types of payout ratios (for example, 80%, 84%, 88%). The symbol weighing data is data indicating the correspondence between the respective symbols, and one or more random numbers which fall in a predetermined numerical range (0 to 255). The payout ratios are determined based on payout-ratio setting data outputted from the GAL 54 and, based on the symbol weighing data associated with the payout ratios, the symbols to be rearranged in the symbol matrix are determined.

Furthers the game programs include feature came determination table data (see FIG. 2A) indicative of the feature game determination table. Further, the game programs include data indicative of the correspondence relation among the type and the number of the feature game and the specific picture (see FIG. 2B). Further, the game programs include odds data (normal odds data and special odds data) indicative of the correspondence relation among the type and the number of the rearranged normal symbols and the number of coin-outs (see FIGS. 7A and 7B).

Further, the card slot 53S is configured so as to allow the memory card 53 to be inserted thereinto or ejected therefrom, and is connected to a mother board 40 via an IDE bus. Thus, the memory card 53 can be ejected from the card slot 53S, and then another game program is written onto the memory card 53, and the memory card 53 can be inserted into the card slot 53S, to change the type and contents or a game to be played on the slot machine 10. The game program includes a program associated with the progress of a game. The game program also includes image data and sound data to be outputted during the game. The image data includes image data indicating a symbol matrix.

The GAL 54 is a type of PLD having a fixed OR array structure. The GAL 54 includes plural input ports and plural output ports and, when predetermined data is inputted to an input port, the GAL 54 outputs data corresponding to the aforementioned data from an output port. The data outputted from this output port is the aforementioned payout-ratio setting data.

Further, the IC socket 54S is configured to allow the CAL 54 to be attached thereto and detached therefrom and is connected to the mother board 40 through a PCI bus. Accordingly, the GAL 54 can be replaced with another GAL 54 to change the payout-ratio setting data.

A CPU 51, a ROM 55 and a boot ROM 52 interconnected to one another via an internal bus are connected to the mother board 40 by PCI bus. The PCI bus supplies power to the gaming board 50 from the mother board 40, as well as transmitting a signal between the mother board 40 and the gaming board 50. The ROM 55 stores country identification information and an authentication program. The boot ROM 52 stores an auxiliary authentication program and a program (boot code) to be used by the CPU 51 for activating the auxiliary authentication program, and the like.

The authentication program is a program (falsification check program) for authenticating a game program and a game system program. The authentication program is written along a procedure (authentication procedure) for checking and proving that a game program and a game system program to be subject to authentication loading processing have not been falsified, namely authenticating the game program and the a game system program. The auxiliary authentication program is a program for authenticating the above-mentioned authentication program. The auxiliary authentication program is written along a procedure (authentication procedure) for proving that an authentication program to be subject to the authentication processing has not been falsified, namely, authenticating the authentication program.

The mother board 40 is constructed with a general-purpose mother board commercially available (a printed circuit board on which basic parts of a personal computer are mounted) and includes a main CPU 41, ROM (Read Only Memory) 42 and RAM (Random Access Memory) 43. The mother board 40 is the controller of the present invention.

ROM 42 is constituted or a memory device such as a flash memory and stores thereon a pro gram such as BIOS (Basic Input/Output System) executed by the main CPU 41 and permanent data. When BIOS is executed by the main CPU 41, not only is initialization processing for predetermined peripheral devices conducted, but a capture processing for the game program and game system program stored on the memory card 53 is also started via the gaming board 50. In the present invention, contents of ROM 42 may be rewritable or not rewritable.

RAM 43 stores data and a program used at the time of operation of the main CPU 41, and various flags. RAM 43 can also store the authentication program read through the gaming board 50, the game program, and the game system program. RAM 43 further stores data on the number of credits, the number of coins-in or coins-out for one game, and the like.

Further, in the RAM 43, a number-of-free-game storage area and a number-of-bonus-game storage area are provided. The number-of-free-game storage area stores data indicating the remaining number of the free game. The number-of-bonus-game storage area stores data indicating the remaining number of the bonus game.

To the mother board 40, a body PCB (Printed Circuit Board) 60 and a door PCB 80, which will be described later, are connected through respective USBs. Further, the mother board 40 is connected with a power supply unit 45. When the power is supplied from the power unit 45 to the mother board 40, the main CPU 41 of the mother board 40 is activated and the power is supplied to the gaming board 50 through the PCI bus so that the CPU 51 is activated.

The body PCB 60 and the door PCB 80 are connected with equipment and devices that generate input signals to be inputted to the main CPU 491, and equipment and devices operations of which are controlled by control signals outputted from the main CPU 41. The main CPU 41 executes a game program stored in the RAM 43 based on an input signal inputted to the main CPU 41, thereby executes the predetermined arithmetic processing and stores a result thereof in the RAM 43, or transmits a control signal to each of the equipment and devices as processing for controlling each of the equipment and devices.

To the body PCB 60, there are connected a lamp 30, a hopper 66, a coin detecting portion 67, a graphic board 68, a speaker 99, a touch panel 69, a bill validator 22, a ticket printer 35, a card reader 36, a key switch 38S, and a data display 37. The lamp 30 lights up in a predetermined pattern based on a control signal outputted from the main CPU 41.

The hopper 66 is installed inside the cabinet 11 and pays out a predetermined number of coins from the coin payout exit 19 to the coin tray 18, based on a control signal outputted from the main CPU 41. The coin detecting portion 67 is provided inside the coin payout exit 19, and outputs an input signal to the main CPU 41 when detecting a payout of a predetermined number of coins from the coin payout exit 19.

The graphic board 68 controls, based on a control signal-outputted from the main CPU 41, an image display to the upper image display panel 33 and the lower image display panel 16. The number of credits stored in RAN 43 is displayed to the number-of-credits display section 31 (not shown) of the lower image display panel 16. The number of coins-out is displayed to the number-of-payouts display section 32 (not shown) of the lower image display panel 16. The graphic board 68 is equipped with VDP (Video Display Processor) which generates image data based on a control signal outputted from the main CPU 41 and a video RAM which temporarily stores image data generated by VDP, and of the like equipments. It should be noted that image data used in generating image data with VDP is contained in a game program read from the memory card 53 and stored in RAM 413.

The bill validator 22 not only discriminates a regular bill from a false bill, but also accepts the regular bill into the cabinet 11. When accepting a regular bill, the bill validator 92 outputs an input signal to the main CPU 41, based on the face amount of the bill. The main CPU 41 stores, in the RAM 43, the number of credits according to the face amount of the bill transmitted with the input signal.

The ticket printer 35 prints an a ticket, based on a control signal outputted from the main CPU 41, a barcode formed by encoding data such as the number of credits, date and timer an identification number of the slot machine 10, and of the like data stored in the RAM 43, and outputs the ticket as a ticket 39 with a barcode.

The card reader 36 reads data from a smart card and transmits the data to the main. CPU 41 or writes data into the smart card based on a control signal from the main CPU 41. The key switch 38S is provided on the keypad 38, and outputs a predetermined input signal to the main CPU 41 when the keypad 38 is operated by the player. The data display 37 displays, based on a control signal outputted from the main CPU 41, data read by the card reader 36 or data inputted by the player through the keypad 38.

To the door PCB 80, there are connected a control panel 20, a reverter 21S, a coin counter 21C, and a cold cathode tube 81. The control panel 20 is provided with a start switch 23S corresponding to the start button 23, a change switch 24S corresponding to the change button 24, a CASHOUT switch 25S corresponding to the CASHOUT button 25, a 1-BET switch 26S corresponding to the 1-BET button 26, and a maximum BET switch 27S corresponding to the maximum BET button 27. Each of the switches 23S to 27S outputs an input signal to the main CPU 41 when each of the buttons 23 to 27 corresponding thereto is operated by the player.

The coin counter 21C is provided inside the coin receiving slot 21 and discriminates a regular coin from a false coin inserted into the coin receiving slot 21 by the player. Coins other than regular coins are discharged from the coin payout exit 19. When the coin counter 21C detects a regular coin, the coin counter 21C outputs an input signal to the main CPU 41.

The reverter 21S operates based on a control signal outputted from the main CPU 41, and distributes a coin identified by the coin counter 21C as a regular coin into a cash box (not shown) or the hopper 66, which are disposed in the slot machine 10. Specifically, when the hopper 66 is filled with coins, a regular coin is distributed into the cash box by the reverter 21S. On the other hand, when the hopper 66 is not filled with coins, the regular coin is distributed into the hopper 66. The cold cathode tube 81 functions as a backlight installed on the rear face side of the lower image display panel 16 and the upper image display panel 33, and lights up based on a control signal to be outputted from the main CPU 41.

Next, processing executed in the slot machine 10 will be described.

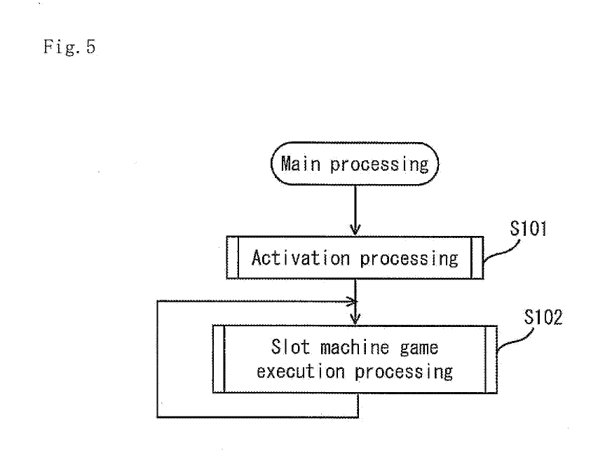

FIG. 5 is a flowchart illustrating main processing executed in the slot machine 10 according to a first embodiment.

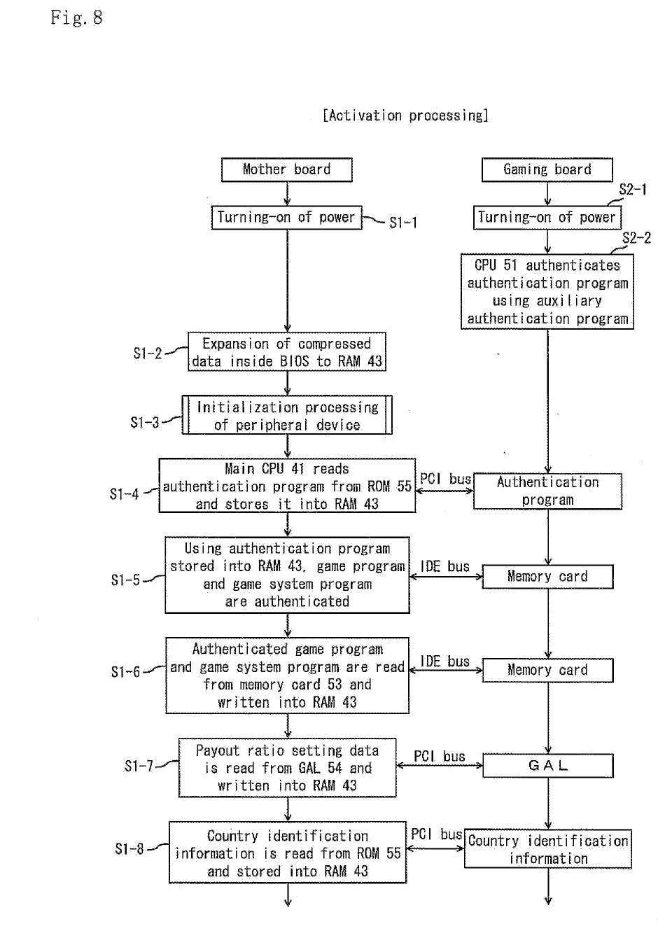

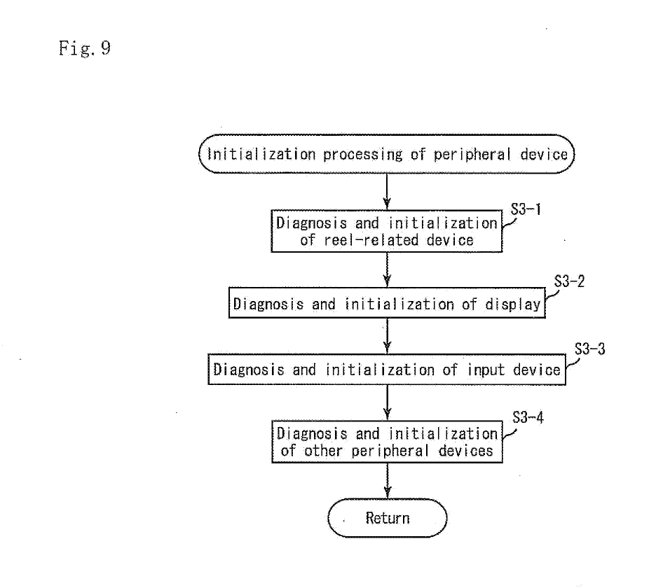

First, in the slot machine 10, activation processing is executed (step S101). The activation processing will be specifically described later by using FIG. 8 to FIG. 10.

After the activation processing, the main CPU 41 executes processing of addition of the number of credits stored in the RAM 43 as an interrupt processing, on receiving a detection signal outputted from the coin counter 21C when the coin inserted into the coin receiving slot 21 is detected by the coin counter 21.

After the processing of step S101, the main CPU 41 executes slot machine game execution processing (step S102).

Hereinafter, there will be described the slot machine game execution) processing performed in the slot machine 10.

The main CPU 41 reads a game program and executes the game program to progress a slot machine game.

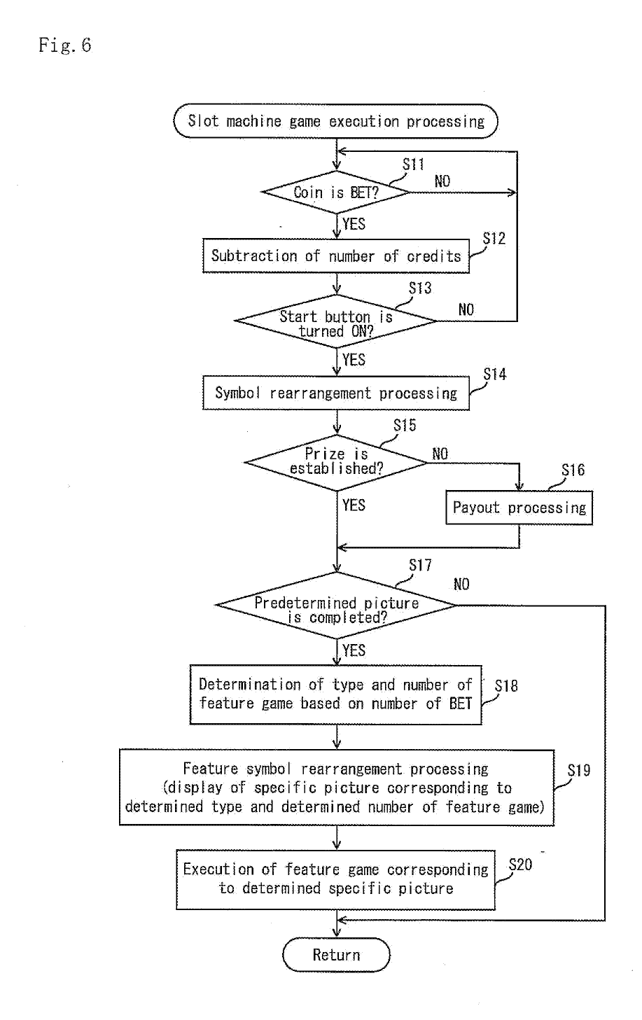

FIG. 6 is a flowchart illustrating a subroutine of slot machine game execution processing.

FIG. 7 is a view illustrating a relation among a type and a number of rearranged normal symbols and a number of coin-outs. First, the main CPU 41 determines whether or not a coin has been BET (step S11). In the processing, the main CPU 41 determines whether or not to have received an input signal outputted from the 1-BET switch 26S when the 1-BET button 26 is operated or an input signal outputted from the maximum BET switch 27S when the maximum BET button 27 is operated. When determining that a coin has not been BET, the main CPU 41 returns the processing to step S11.

On the other hand, when determining that a coin has been BET in step S11, the main CPU 41 executes processing for making a subtraction from the number of credits stored in the RAM 43, according to the number of BET coins (step S12). It should be noted that, when the number of BET coins is larger than the number of credits stored in the RAN 43, the main CPU 41 does not execute the processing for making a subtraction from the number of credits stored in the RAM 43, and returns the processing to step S11. When the number of BET coins exceeds an upper limit of the number of coins (that can be BET on a single game (30 coins in the present embodiment), the main CPU 41 does not execute the processing for making a subtraction from the number of credits stored in the RAM 43, and the processing is proceeded to step S13.

Next, the main CPU 41 determines whether or not the start button 23 has been turned on (step S13). In the processing, the main CPU 41 determines whether or not to have received an input signal outputted from the start switch 23S when the start button 23 is pressed.

When determining that the start button 23 has not been turned ON, the main CPU 41 returns the processing to step Sit. It should be noted that, when the start button 23 is not turned ON for example, when a command to end the game is inputted without pressing the start button 23), the main CPU 41 cancels a result of the subtraction obtained in step S12.

On the other hand, when determining in step S13 that the start button 293 has been turned ON, the main CPU 41 executes symbol rearrangement processing (step S14).

In the processing, at first, the main CPU 41 starts scroll-display of the symbols (normal symbol and special symbol) in the symbol matrix SM in the downward direction. The processing executed here by the main CPU 41 includes the following processing.

For example, the main CPU 41 respectively displays three symbols (for example “Q”, “K” and “SUN”) in three areas (the upper row, the middle row, and the lower row) included in the first display area 100A for a predetermined time T (for example, 0.1 seconds), and then terminates the display. Thereafter, out of the three symbols, the main CPU 41 displays the symbol having been displayed in the upper low (“Q”) in the middle row of the first display area 100A, the symbol having been displayed in the middle low (“K”) in the lower row of the first display area 100A, and a symbol other than those symbols (for example, “10”) in the upper row of the first display area 100A. After performing the display for a predetermined time T′ (for example, T′≦T), the main CPU 41 terminates the display. The main CPU 41 executes the processing repeatedly. Further, the main CPU 41 executes virtually the same processing also in the second display area 101E to the fifth display area 100E.

The main CPU 41 determines the symbols to be rearranged by executing the above-described symbol selection program, and rearranges the symbols based on the result of the symbol determination in the first display area 100A to the third display area 100C.

Then, the main CPU 41 determines whether or not the rearrangement is in the li-zhi state for the completion of the predetermined picture. Namely, the main CPU 41 determines whether or not the six symbols rearranged in the second display area 100B and the third display area 1000 are the special symbols for forming the predetermined picture. When determining that the rearrangement is not in the li-zhi state for completion of the predetermined picture, the main CPU 41 rearranges the symbols based on the result of the above-described symbol determination in the fourth display area 110D to the fifth display area 100E.

On the other hand, when determining that the rearrangement is in the li-zhi state for the completion of the predetermined picture, the main CPU 41 displays the li-zhi text image 120 (see FIG. 1B) to the lower image display panel 16. Then, the main CPU 41 rearranges the symbols based on the result of the above-described symbol determination in the fourth display area 1000. Then, the main CPU 41 determines whether or not the predetermined picture is completed Namely, the main CPU 41 determines whether or not the nine symbols rearranged in the second display area 100B to the fourth display area 100D are the special symbols for forming the predetermined picture.

When determining that the predetermined picture is not completed, the main CPU 41 displays the bad-luck i-mage 121 (see FIG. 1C) to the lower image display panel 16.

On the other hand, when determining that the predetermined picture is completed, the main CPU 41 displays the picture-completion text image 122 (see FIG. 10) to the lower image display panel 16.

Thereafter, the main CPU 41 rearranges the symbols based on the result of the above-described symbol determination in the fifth display area.

After executing the processing of step S14, the main CPU 41 determines whether or not a prize is established (step S17). Here, the establishment of the prize refers to the rearrangement of two or more normal symbols of at least one type, out of “10”, “J”, “Q”, “K”, “UMBRELLA”, “CLOUD”, “THUNDER”, and “SUN”, in the symbol matrix SM (see FIG. 7). In the processing, the main CPU 41 counts the number of normal symbol for each type, with regard to the rearranged symbols in step S14. Then, the main CPU 41 determines whether or not the counted number is equal to or more than two.

When determining that the prize has been established, the main CPU 41 executes processing according to payout of the coin (step S16). In the processing, the main CPU 41 determines the number of coin-outs based on the number of rearranged symbols with reference to the normal odds data (see FIG. 7A) stored in the RAM 43.

For example, in the case that two “SUN” are rearranged when 2 coins are BET, the number of coin-outs is 50 (=25×2).

In the case of accumulating the coin, the main CPU 41 executes processing for adding a number of credits corresponding to the determined number of coin-outs. On the other hand, in the case of paying out coins, the main CPU 41 transmits a control signal to the hopper 66 in order to pay out the coin in number corresponding to the determined number of coin-outs.

When determining that the prize has not been established in step S15 or after executing the processing of step S16, the main CPU 41 determines whether or not the predetermined picture is completed by the special symbols rearranged in the second display area 100B to the fourth display area 100D (step S17). When determining that the predetermined picture is not completed, the main CPU 41 terminates the present subroutine.

On the other hand, when determining that the predetermined picture is completed, the main CPU 41 determines the type and the number of the feature game based on the number of coin BET in step S11 (number of BET) (step S18). At this time, the main CPU 41 refers to the feature game determination table data (see FIG. 2) stored in the RAM 43.

In the processing, the main CPU 41 generates a random number to select a single random number. Then, the main CPU 41 determines the type and the number of the feature game based on the value of the selected random number and the number of BET.

For example, in the case that the value of the selected random number is 46 and the number of BET is 8, the main CPU 41 determines the type of the feature game to the free game and the number of the feature game to 10 games.

Further, in the case that the value of the selected random number is 115 and the number of BET is 30, the main CPU 41 determines the type of the feature game to the free game and the number of the feature game to 50 games.

As thus described, according to the present embodiment, the number of the feature game is increased in comparison with the increase of the number of BET.

After executing the processing of step S18, the main CPU 41 executes feature symbol rearrangement processing (step S19).

In the processing, the main CPU 41 scroll-displays the feature symbols rightward first. The processing executed by the main CPU 41 here includes the following processing.

For example, the main CPU 41 respectively displays five symbols (for example, “Q”, “K”, “SUN”, “10”, and “J”) in five areas (the first display area 100A, the second display area 100B, the third display area 100C, the fourth display area 100D, and the fifth display area 100E) included in the upper row of the symbol matrix SM for the predetermined time T (for example, 0.1 seconds), and then terminates the display. Then, out of the five symbols, the main CPU 41 displays the symbol (“Q”) having been displayed in the first display area 100A in the second display area 100B of the upper row, the symbol (“K”) having been displayed in the second display area 100B in the third display area 100C of the upper row, the symbol (“SUN”) having been displayed in the third display area 100D in the fourth display area 100D of the upper row, the symbol (“10”) having been displayed in the fourth display area 100D in the fifth display area 100D of the upper row, and a symbol (for example, “THUNDER”) other than those symbols in the first display area 100A of the upper row. After performing the display for the predetermined time T′ (for example, T′≦T, the main PCU 41 terminates the display. The main CPU 41 executes the processing repeatedly. Further, the main CPU 41 executes virtually the same processing also in the middle row and the lower row.

Then, the main CPU 41 determines the feature symbols for forming the specific picture corresponding to the type and the number of the feature game determined in step S18. The main CPU 41 rearranges the determined feature symbols in the second display area 100B to the fourth display area 100D.

As a result, the specific pictures shown in FIGS. 1F to 1I are displayed.

After executing the processing of step S319, the main CPU 41 executes the feature game (the free game or the bonus game) of the type determined in step S18 for the determined times (step S20).

In the processing, the main CPU 41 sets the remaining number of the free game or the bonus game to the number determined in step S18 in the number-of-free-game storage area or the number-of-bonus-game storage area in the RAM 43.

(I) In the case that the type of the feature game determined in step S18 is the free game, the main CPU 41 executes virtually the same processing as the processing of step S13 to step S16 in FIG. 6, regarding that the coins are BET in the same number as the number of coins BET in the game (game in which the predetermined picture is completed) as a trigger for generating the free game without subtracting the number of credits.

(II) In the case that the type of the feature game determined in step S16 the bonus game, the main CPU 41 executes virtually the same processing as the processing of step S311 to step S16 in FIG. 6. However, the main CPU 41 determines the number of coin-outs, in the payout processing, with reference to the special odds data, not to the normal odds data.

The main CPU 41 decreases the remaining number of the free game or the bonus game by 1 for each execution of a single game of the free game or the bonus game in the number-of-three-game storage area or the number-of-bonus-game storage area in the RAM 43.

Then, the main CPU 41 executes the processing of (I) or (II) until the remaining number of the free game or the bonus game becomes zero.

After executing the processing of step S20, the main CPU 41 terminates the present subroutine.

Subsequently, there will be described activation processing (see step S101 in FIG. 5) by using FIG. 8 to FIG. 10.

FIG. 8 is a flowchart illustrating a procedure of activation processing. This activation processing is the processing conducted by the mother board 40 and the gaming board 50. It should be noted that the memory card 53 is inserted into the card slot 53S in the gaming board 50, and the GAL 54 is mounted onto the IC socket 54S.

First, when a power switch is turned on (power is turned on) in the power supply unit 45, the mother board 40 and the gaming board 50 are activated (steps S1-1, S2-1) In activation of the mother board 40 and the gaming board 50, individual processing is respectively executed in parallel. Namely, in the gaming board 50, the CPU 51 reads the auxiliary authentication program stored in the boot ROM 52, and conducts auxiliary authentication according to the read auxiliary authentication program, to previously check and prove that the authentication program is not falsified before loading the program to the mother board 40 (step S2-2). Meanwhile, in the mother board 40, the main CPU 41 executes the BIOS stored in the ROM 42, and expands compressed data which is incorporated in the BIOS into the RAM 43 (step S1-2). The main CPU 41 then executes the BIOS expanded into the RAM 43 to diagnose and initialize a variety of peripheral devices (step S1-3). The processing of step S1-3 will be specifically described later with reference to FIG. 12.

Since the ROM 55 of the gaming board 50 is connected to the main CPU 41 via the PCI bus, the main CPU 41 reads the authentication program stored in the ROM 55, and stores the read authentication program into the RAM 43 (step S1-4). At this time, according to the standard BIOS function of BIOS, the main CPU 41 takes a checksum by ADDSUM system (normal checking system) and stores the authentication program into the RAM 43, while conducting processing for confirming whether or not the storage is certainly conducted.

Next, after confirming what is connected to the IDE bus, the main CPU 41 accesses, via the IDE bus, the memory card 53 inserted in the card slot 53S, to read a game program or a game system program from the memory card 53. In this case, the main CPU 41 reads data constituting the game program and the game system program by 4 bytes. Subsequently, the main CPU 41 conducts authentication to check and prove that the read game program and game system program have not been falsified, following the authentication program stored in the RAM 43 (step S1-5). When this authentication processing is normally completed, the main. CPU 41 writes and stores the game program and the game system program, which have been the authentication targets (which have been authenticated), into the RAM 43 (step S1-6). Next, the main CPU 41 accesses, via the PCI bus, the GAL 54 mounted on the IC, socket 54S, reads payout ratio setting data from the GAL 54, and writes and stores the data into the RAM 43 (step S1-7). Subsequently, the main CPU 41 conducts processing for reading country identification information stored in the ROM 55 of the gaming board 50 via the PCI bus, and writes and stores the read country identification information into the RAM 43 (step S3-8).

After conducting the above-mentioned processing, the main CPU 41 sequentially reads and executes the game program and the game system program, thereby execute insurance setting processing and game execution processing.

FIG. 9 is a chart illustrating a procedure of peripheral-device initialization processing.

First, the main CPU 41 diagnoses and initializes a reel-related device (step S3-1). In this processing, the main CPU 41 sequentially transmits request signals to the index detecting circuit 65, the position-change detecting circuit 71, and the motor driving circuit 62. Then, the main CPU 41 determines whether or not to have received predetermined response signals and conducts clearance of a predetermined storage area, and the like.

Next, the main CPU 41 diagnoses and Initializes a display (step S3-2). In this processing, the main CPU 41 transmits the request signal to the graphic board 68. Then, the main CPU 41 determines whether or not to have received a predetermined response signal and conducts clearance of a predetermined storage area, and the like.

Next, the main CPU 41 diagnoses and initializes various types of input devices (step S3-3). In this processing, the main CPU 41 transmits request signals to the input devices such as the spin switch 23S, the change switch 24S, the CASHOUT switch 25S, the 1-BET switch 268, the maximum BET switch 27S, and the touch panel 11, and then determines whether or not to have received predetermined response signals.

Subsequently, the main CPU 41 diagnoses and initializes other peripheral devices connected to the main CPU 41 (step S3-4). Then the present subroutine is terminated.

In the present embodiment, there has been described the case where the slot machine 10 is a stand-alone type slot machine. However, in the present invention, a plurality of slot machines may be connected to a central controller via a network and controlled by the central controller.

FIG. 10 is a chart illustrating a procedure of activation processing executed by the central controller.

First, when the power switch is turned on (the power is turned on) in the power unit, a mother board is activated (step S4-1).

In the mother board, a CPU executes a BIOS stored in a ROM so as to expand compressed data incorporated in the BIOS into a RAM (step S4-2). Then, the CPU executes the BIOS expanded into the RAM, and then, diagnoses and initializes various types of peripheral devices such as a display (step S4-3).

Next, the CPU executes initialization processing of each slot machine. In this processing, the CPU establishes a network connection between the central controller and each slot machine, and diagnoses if the network functions properly.

After the above-described processing, the CPU controls proceeding of the game executed in a plurality of the slot machines by reading and executing a game control program.

According to the slot machine IC of the present embodiment, a condition for generation of the feature game (the free game or the bonus game) is a completion of a predetermined picture in the symbol matrix SM, and the condition is different from a mere arrangement or a mere number of the symbols and is visibly very clear to the player. Accordingly, it is easier to have the player have an expectation for the completion of such a predetermined picture, and player's interest in the feature game can be fully attracted.

Further, according to the slot machine 10 of the present embodiment, as triggered by an establishment of such a condition for the generation of a feature game, the feature symbols are rearranged after scroll-displayed in the predetermined display area in which the predetermined picture have been displayed (the second display area 100B to the fourth display area 100D). In the case that the predetermined picture is completed, it is highly possible that the player's attention is focused on, the area displaying the picture therein. In such area, a scroll-display of the feature symbols is started. Further, the player usually does not experience another variable display of the symbols after the symbols are once stop-displayed and before the next game is started. Accordingly, it is possible to have the player visibly enjoy a state of the scroll-display of the feature symbols, as well as having the player surprised. Further, the player's expectation for the completion of the predetermined picture can be increased. As a result, the player's interest in the feature game is also increased.

According to the slot machine 10 of the present embodiment, the normal symbols and the special symbols are scroll-displayed in different directions. Accordingly, since the direction of the scroll-display of the feature symbols is different from the direction familiar to the player, it is possible to provide a novel element to the player watching the state of the scroll-display of the feature symbols. Accordingly, the player's expectation for the completion of the predetermined picture can be further increased.

Furthermore, according to the slot machine 10 of the present embodiment, after the completion of the predetermined picture, the specific picture is displayed as a result of sorting of the symbols. Accordingly, the player can visibly enjoy sequential events including the completion of the predetermined picture, the variable display of the feature symbols, and the display of the specific picture. Consequently, the player's interest in the predetermined picture, specific picture and the feature symbols can be significantly increased, so that the player can be absorbed in the game.

According to the slot machine 10 of the present embodiment, it is possible to have the player recognize what type of the feature game (the free game or the bonus game) for what number of times (10 times or 50 times) to be executed by watching the type of the specific picture formed by the stop-displayed feature symbols. Therefore, it is possible to have the player greatly interested in which specific picture to be displayed. Accordingly, in the case that the displayed specific picture is corresponding to the feature game desired by the player, the player may be delighted, and in the case that the displayed specific picture is corresponding to the feature game not desired by the player, the player may be disappointed. As a result, what type of the specific picture is displayed can take the player through emotional ups and downs. Consequently, the player can be absorbed in the game.

In the above-described embodiment, there has been described the case where the symbols (the normal symbol and the special symbol) are rearranged in the symbol matrix SM in the lower image display panel 16 (the case where the slot machine 10 is a so-called video slot machine). However, a slot machine of the present invention may be configured such that the symbols (the normal symbol and the special symbol) are stop-displayed by using a so-called mechanical reel.

In the following, a slot machine 310 having such a configuration will be described.

It is to be noted that in the following, the same constituents as those of the slot machine 10 according to the first embodiment are described while provided with the same numerals.

Further, a description will be omitted as for a part to which the description of the slot machine 10 is applicable.

FIG. 11 is a perspective view illustrating an external appearance of a s-lot machine according to another embodiment.

As illustrated in FIG. 11, five reels 314 (314A, 314B, 314C, 314D and 314E) are rotatably provided within a cabinet 11. On the outer peripheral surfaces of the reels 314A, 314B, 314C, 314D and 314E, there are drawn symbol sequences constituted by normal symbols such as “10”, “J”, “Q”, “K”, “UMBRELLA”, “CLOUD”, “THUNDER”, and “SUN”, and the special symbols each showing a picture piece for forming the predetermined picture (picture 110, see FIG. 1D).

At the center portion of the lower image display panel 16, there is provided a display area 328 for displaying the symbols. Within the display area 328, there are formed five display windows 315 (315A, 315B, 315C, 315D and 315E) visible through their backs surfaces. Further, the symbols drawn on the outer peripheral surfaces of the reels 314A, 314B, 314C, 314D and 314E are displayed on a three-by-three basis, through the display windows 315A, 315B, 315C, 315D and 315E.

As triggered by the display of the predetermined picture (the predetermined picture is completed) by the special symbols stop-displayed on the reel 314B, the reel 314C and the reel 314D, the main CPU 41 executes the following processing.

First, the main CPU 41 determines the type and the number of the feature came based on the number of BET (see step S18 in FIG. 6).

Then, the main CPU 41 executes the feature symbol rearrangement processing (see step S19 in FIG. 6) in a predetermined position of the display area 328. The predetermined position refers to the position to which the symbols (nine special symbols for forming the predetermined picture) drawn on the peripheral faces of the reel 314B, the reel 314C and the reel 314D are displayed. The main CPU 41 displays an opaque symbol matrix to the position. The symbol matrix is capable of rearranging a total of nine feature symbols in three rows and three columns therein. The main CPU 41 rearranges in the symbol matrix the feature symbols for forming the specific picture corresponding to the type and the number of the feature game determined based on the number of BET.

Then, the main CPU 41 executes the feature game of the type determined based on the number of BET for the number of times determined based on the number of SET (see step S20 in FIG. 6).

The processing according to the determination of the feature symbols to be rearranged, the feature symbol rearrangement processing, and the processing according to the execution of the feature game are virtually the same processing as the processing of step S18 to step S20 in FIG. 6, and therefore, the detailed description thereof will be omitted.

As a result of the above processing executed by the main CPU 41, after the scroll-display of the feature symbols are conducted in such a manner that the symbols drawn on the peripheral faces of the reels 314B, 314C, and 314D (nine special symbols for forming the predetermined picture) are covered, the specific picture is displayed and the feature game of the type corresponding to the specific picture is executed for the number of 1 times corresponding to the specific picture.

Although the present invention has been described with reference to embodiments thereof these embodiments merely illustrate concrete examples, not restrict the present invention. The concrete structures of respective means and the like can be designed and changed as required. Furthermore, there have been merely described most preferable effects of the present invention, as the effects of the present invention, in the embodiments of the present invention. The effects of the present invention are not limited to those described in the embodiments of the present invention.

Further, in the aforementioned detailed description, characteristic portions have been mainly described, for ease of understanding the present invention. The present invention is not limited to the embodiments described in the aforementioned detailed description, but can be also applied to other embodiments over a wider range of applications. Further, the terms and phrases used in the present specification have been used for clearly describing the present invention, not for limiting the interpretation of the present invention. Further, those skilled in the art wile easily conceive other structures, systems, methods and the like which are included in the concept of the present invention, from the concept of the present invention described in the present specification. Accordingly, the description of the claims is intended to include equivalent structures that fall within the technical scope of the invention. Further, the abstract aims at enabling engineers and the like who belong to the present technical field but are not familiar with the patent office and public institutions, the patent, law terms and technical terms to immediately understand the technical content and the essence of the present application through brief studies. Accordingly, the abstract is not intended to restrict the scope of the invention which should be evaluated from the description of the claims. It is desirable that literatures and the like which have been already disclosed are sufficiently studied and understood, in order to sufficiently understand the objects of the present invention and the specific effects of the present invention.

In the aforementioned detailed description, there have been described processing to be executed by computers. The aforementioned description and expressions have been described for the sake of enabling those skilled in the art to understand the present invention most effectively. In the present specification, each step for deriving a single result should be understood to be self-consistent processing. Further, each step includes transmission, reception, recording and the like of electric or magnetic signals. Although, in the processing at each step, such signals have been expressed as bits, values, symbols, characters, terms, numerical characters and the like, it should be noticed that they have been merely used for convenience of description. Further, although the processing at each step was described using expressions common to human behaviors in some cases, the processing described in the present specification are to be executed by various types of devices, in principle. Further, other structures required for conducting each step will be apparent from the aforementioned description.

What is claimed as new and desired to be secured by Letters Patent of the United States is:

1. A slot machine comprising:
a symbol display capable of variably displaying a plurality of symbols including normal symbols and special symbols each showing a picture piece for forming a predetermined picture, and
a controller,
said controller programmed to execute processing of
(A) executing a normal game after stop-displaying said plurality of symbols subsequent to a variable display of said plurality of symbols to said symbol display, said normal game being a game offering a normal payout corresponding to the stop-displayed normal symbols or a combination of the stop-displayed normal symbols; and
(B) executing a feature game different from said normal game, as well as stop-displaying a plurality of feature symbols different from said plurality of symbols after variably displaying said plurality of feature symbols in a predetermined display area in said symbol display, as triggered by formation of said predetermined picture by the picture pieces shown by the special symbols stop-displayed in said predetermined display area, out of the special symbols stop-displayed to said symbol display in said normal game executed in said processing (A).

2. The slot machine according to claim 1,
wherein
said processing (A) includes processing of
displaying variably said plurality of symbols in a predetermined direction, and
said processing (B) includes processing of
displaying variably said plurality of feature symbols in a direction different from said predetermined direction.

3. A slot machine comprising:
a symbol display capable of variably displaying a plurality of symbols including normal symbols and special symbols each showing a picture piece for forming a predetermined picture; and
a controller,
said controller programmed to execute processing of
(A) executing a normal game after stop-displaying said plurality of symbols subsequent to a variable display of said plurality of symbols to said symbol display, said normal game being a game offering a normal payout corresponding to the stop-displayed normal symbols or a combination of the stop-displayed normal symbols; and
(B) executing a feature game different from said normal game, as well as stop-displaying feature symbols each showing a feature picture piece for forming a specific picture so as to form said specific picture, after variably displaying said feature symbols in a predetermined display area in said symbol display, as triggered by formation of said predetermined picture by the picture pieces shown by the special symbols stop-displayed in said predetermined display area, out of the special symbols stop-displayed to said symbol display in said normal game executed in said processing (A).

4. The slot machine according to claim 3,
wherein
a plurality of types of said specific picture are provided, and
said controller is further programmed to execute processing of
(C) determining a type of said specific picture, and
said processing (B) is processing or
(B-1) stop-displaying said feature symbols so as to form the specific picture of the type determined in said processing (C) after variably displaying said feature symbols in a predetermined display area in said symbol display, as triggered by formation of said predetermined picture by the picture pieces shown by the special symbols stop-displayed in said predetermined display area, out of the special symbols stop-displayed to said symbol display in said normal game executed in said processing (A), and
(B-2) executing a feature game corresponding to the type of the specific picture determined in said processing (C).

5. A control method of a slot machine, said control method comprising steps of:
(A) executing a normal game after stop-displaying a plurality of symbols including normal symbols and special symbols each showing a picture piece for forming a predetermined picture subsequent to a variable display of said plurality of symbols to a symbol display, said normal game being a game offering a normal payout corresponding to the stop-displayed normal symbols or a combination of the stop-displayed normal symbols; and
(B) executing a feature game different from said normal game, as well as stop-displaying a plurality of feature symbols different from said plurality of symbols after variably displaying said plurality of feature symbols in a predetermined display area in said symbol display, as triggered by formation of said predetermined picture by the picture pieces shown by the special symbols stop-displayed in said predetermined display area, out of the special symbols stop-displayed to said symbol display in said normal game executed in said step (A).

6. A control method of a slot machine, said control method comprising steps of:
(A) executing a normal game, after stop-displaying a plurality of symbols including normal symbols and special symbols each showing a picture piece for forming a predetermined picture subsequent to a variable display of said plurality of symbols to a symbol display, said normal game being a game offering a normal payout corresponding to the stop-displayed normal symbols or a combination of the stop-displayed normal symbols; and
(B) executing a feature game different from said normal game, as well as stop-displaying feature symbols each showing a feature picture piece for forming a specific picture so as to form said specific picture, after variably displaying said feature symbols in a predetermined display area in said symbol display, as triggered by formation of said predetermined picture by the picture pieces shown by the special symbols stop-displayed in said predetermined display area, out of the special symbols stop-displayed to said symbol display in said normal game executed in said step (A).
